(19) United States
(12) Patent Application Publication
(10) Pub. No.: US 2012/0279743 A1
(43) Pub. Date: Nov. 8, 2012

(54) ELECTRIC POWER TOOL

(75) Inventors: Hidekazu Suda, Anjo-shi (JP); Ryosuke Ito, Anjo-shi (JP); Takuya Kusakawa, Anjo-shi (JP)

(73) Assignee: MAKITA CORPORATION, Anjo-shi, Aichi (JP)

(21) Appl. No.: 13/519,041

(22) PCT Filed: Dec. 20, 2010
(86) PCT No.: PCT/JP2010/072917

§ 371 Date: Jun. 25, 2012

(30) Foreign Application Priority Data
Dec. 28, 2009 (JP) 2009-298292

(51) Int. Cl. B25F 5/00

(52) U.S. Cl. 173/176

(57) ABSTRACT

An electric power tool includes an electric motor, a rotation speed detection device, a brake device, and a rotation speed-based activation device. The electric motor generates a driving force to rotate an object to be driven. The rotation speed detection device detects a rotation speed of the electric motor. The brake device executes braking control to brake the electric motor. The rotation speed-based activation device activates the brake device when the rotation speed detected by the rotation speed detection device becomes equal to or less than a specified rotation speed, which is arbitrarily set, after a stop command to shut off electric current supply to the electric motor is issued.

### CROSS-REFERENCE TO RELATED APPLICATIONS

This international application claims the benefit of Japanese Patent Application No. 2009-298292 filed Dec. 28, 2009 in the Japan Patent Office, the disclosure of which is incorporated herein by reference.

### TECHNICAL FIELD

The present invention relates to an electric power tool.

### BACKGROUND ART

A conventional brush cutter includes a battery, an electric motor, and a cutter (for example, a cutting blade, a nylon cord cutter, etc.), and is configured such that the cutter is connected to a drive shaft of the electric motor via a driving force transmission mechanism (i.e., a gear, a transmission shaft, etc.).

In such a brush cutter, it is required that rotation of the electric motor, and thus of the cutter, is rapidly stopped after stopping of the electric motor is commanded.

As a method for stopping rotation of the cutter, it is disclosed to use regenerative braking in Patent Document 1 below. In regenerative braking, when current-carrying to a coil of the electric motor is shut off and a short circuit is made between both ends of the coil, a large braking force is generated to a rotor of the electric motor. That is, rotation of the rotor, and thus rotation of the cutter can be stopped rapidly by means of regenerative braking.

### PRIOR ART DOCUMENTS

### Patent Document

Patent Document 1: Japanese Unexamined Patent Application Publication No. 08-66074

### SUMMARY OF THE INVENTION

### Problems to be Solved by the Invention

When rotation of the rotor of the electric motor is rapidly stopped in the above-described brush cutter, recoil caused by kinetic energy owned by the cutter is applied to the driving force transmission mechanism (and thus to a hollow pipe). Then, such recoil may be one reason for reducing usability of the brush cutter.

Therefore, it is an objective to provide an electric power tool that can suppress deterioration of usability of the electric power tool due to braking of the electric motor.

### Means for Solving the Problems

An electric power tool in the present invention, which has been made in order to achieve the above objective, includes an electric motor, a rotation speed detection device, a brake device, and a rotation speed-based activation device.

In the electric power tool, the electric motor generates a driving force to rotate an object to be driven, while the rotation speed detection device detects a rotation speed of the electric motor. When the rotation speed detected by the rotation speed detection device becomes equal to or less than a specified rotation speed, which is arbitrarily set, after a stop command to shut off electric current supply to the electric motor is issued, the rotation speed-based activation device activates the brake device, and the brake device executes braking control to brake the electric motor.

Specifically, in the electric power tool, reduction in the rotation speed of the electric motor, that is, reduction in the kinetic energy owned by the object to be driven during rotation after the stop command is issued is waited, and then the braking control is executed.

In the electric power tool, therefore, recoil applied to the electric power tool due to braking of the electric motor may be reduced since braking of the electric motor is performed after the rotation speed of the electric motor is reduced to the specified rotation speed. That is, according to the electric power tool, deterioration in usability of the electric power tool resulting from braking of the electric motor may be suppressed.

The electric power tool of the present invention may also include a time-based activation device that activates the brake device when a braking control start time, which is an arbitrarily set time length, has elapsed since a stop command is issued.

In this case, even if the rotation speed of the electric motor is larger than the specified rotation speed, braking control may be executed after the arbitrarily set time has elapsed since the stop command is issued.

The specified rotation speed may be set depending on a state of use of the electric power tool. In this case, the electric power tool of the present invention may include a specified speed setting device that sets the specified rotation speed.

The electric power tool of the present invention may further include a reduction rate calculation device that sequentially calculates a reduction rate, which is a rate of reduction in the rotation speed of the electric motor during a unit time period, in accordance with a detection result by the rotation speed detection device. In this case, the specified speed specifying device may be configured to set the specified rotation speed based on the reduction rate calculated by the reduction rate calculation device. The specified speed setting device may set a larger value, as the specified rotation speed, as the reduction rate becomes larger.

Also, the electric motor may be configured to be rotatable in a forward rotation direction and in a reverse rotation direction. In this case, the specified speed setting device preferably sets the specified rotation speed individually for each of the forward rotation direction and the reverse rotation direction.

With the specified speed setting device configured as above, the specified rotation speed may be appropriately set individually for each of the forward rotation direction and the reverse rotation direction.

The braking control start time may be set depending on a state of use of the electric power tool. In this case, the electric power tool of the present invention preferably includes a time setting device that sets the braking control start time.

With the electric power tool configured as above, the braking control start time may be set by the electric power tool itself.

Further, the electric power tool of the present invention may include a reduction rate calculation device that sequentially calculates a reduction rate, which is a rate of reduction in the rotation speed of the electric motor during a unit time period, in accordance with a detection result by the rotation speed detection device. In this case, the time setting device is preferably configured to set the braking control start time based on the reduction rate calculated by the reduction rate calculation device.

According to the electric power tool configured as above, it is possible to set the braking control start time depending on the rate of reduction in the rotation speed of the electric motor during a unit time period.

The time setting device preferably sets a shorter time length, as the braking control start time, as the reduction rate becomes larger.

The electric power tool of present invention may include a rotation speed command switch to set a command value of the rotation speed of the electric motor and a command value obtaining device that obtains the command value set by the rotation speed command switch. In this case, the time setting device may set the braking control start time based on an off-time rotation speed, which is a rotation speed when the command value obtained by the command value obtaining device becomes within a stop range where it is regarded that stopping of the electric motor is commanded.

According to the above-configured electric power tool of the present invention, it is possible to set the braking control start time depending on a state of use of the electric power tool when an attempt is made to stop the rotation of the electric motor.

In this case, the time setting device preferably sets a longer time length, as the braking control start time, as the off-time rotation speed becomes larger.

With the time setting device configured as above, it is possible to wait until a longer time length has elapsed as the off-time rotation speed is larger, and then execute the braking control.

The electric power tool may include a sensor that directly detects the off-time rotation speed, or may include an estimation device that estimates the off-time rotation speed based on the command value obtained by the command value obtaining device.

When an estimation device is included, the estimation device preferably estimates the off-time rotation speed as a larger value as the command value before the specified time, at which the command value becomes within the stop range, becomes larger.

Also, one of the objects to be driven may be selected from among a plurality of types of objects to be driven, and the electric power tool may be configured such that the object to be driven selected from among the plurality of types of objects to be driven is attachable thereto. In this case the time setting device is preferably configured to set, as the braking control start time of the electric power tool, a braking control start time corresponding to an object to be driven having a maximum inertia among the plurality of types of objects to be driven.

With the time setting device configured as above, it is possible to start braking of the electric motor such that recoil resulting from the braking of the electric motor is suppressed regardless of which one of the plurality of types of objects to be driven is attached to the electric power tool.

Further, the electric motor may be configured to be rotatable in the forward rotation direction and in the reverse rotation direction. In this case, the time setting device is preferably configured to set the braking control start time individually for each of the forward rotation and the reverse rotation.

With the time setting device configured as above, it is possible to set the appropriate braking control start time individually for each of the forward rotation and the reverse rotation.

For example, when the electric power tool is configured such that the rotation speed in the reverse rotation direction is lower as compared with the rotation speed in the forward rotation direction, it is preferable that the braking control start time for the reverse rotation direction is set to a shorter time length as compared with the braking control start time for the forward rotation direction.

That is, even if the electric motor is rotated in the reverse rotation direction at a maximum speed, the kinetic energy owned by the object to be driven during rotation is smaller as compared with a case of rotating the electric motor in the forward rotation direction at a maximum speed. Accordingly, it is possible to execute the braking control at a more appropriate timing even when the electric motor is rotated in the reverse rotation direction by setting the braking control start time for the reverse rotation direction to a smaller value than the braking control start time for the forward rotation direction.

Moreover, the electric power tool of the present invention may include a driving force transmission mechanism that transmits the driving force of the electric motor to the object to be driven.

According to the electric power tool with such configuration, it is possible to reduce a possibility that an unexpectedly large kinetic energy is exerted on the driving force transmission mechanism. Thus, it is possible to suppress accumulation of fatigue in the driving force transmission mechanism, thereby lengthening the life of the driving force transmission mechanism.

### BRIEF DESCRIPTION OF THE DRAWINGS

FIG. 1 is a perspective view showing an appearance of an electric power tool in a first embodiment.

FIG. 2 is a block diagram showing an electrical configuration of the electric power tool in the first embodiment.

FIG. 3 is a flowchart of a main routine executed by a microcomputer in the first embodiment.

FIG. 4 is a flowchart of an electric motor driving process executed by the microcomputer in the first embodiment.

FIG. 5 is a flowchart showing process steps of an electric motor driving process in a second embodiment.

FIG. 6A is a flowchart showing a part of process steps of an electric motor driving process in a third embodiment.

FIG. 6B is a flowchart showing remaining process steps of the electric motor driving process in the third embodiment.

FIG. 7 is a block diagram showing an electrical configuration of an electric power tool in a fourth embodiment.

FIG. 8 is a block diagram showing an electrical configuration of an electric power tool in a modified example.

### EXPLANATION OF REFERENCE NUMERALS

1, 70 . . . electric power tool 2 . . . shaft pipe 3 . . . motor unit 4 . . . cutter 6 . . . gear unit 7 . . . battery 8 . . . handle 9 . . . right-hand grip 10 . . . left-hand grip 11 . . . lock-off switch 12 . . . trigger switch 13 . . . forward-reverse selector switch 14 . . . control circuit 14A . . . microcomputer 17, 75 . . . position detection unit 18, 76 . . . electric motor 20, 40 . . . bridge circuit 31-36 . . . gate circuit 77 . . . battery Q1-Q6, Q41-Q44, Q51, Q52 . . . switching device

### MODE FOR CARRYING OUT THE INVENTION

Hereinafter, embodiments of the present invention will be described with reference to the drawings.

### First Embodiment

### <Overall Configuration of Electric Power Tool>

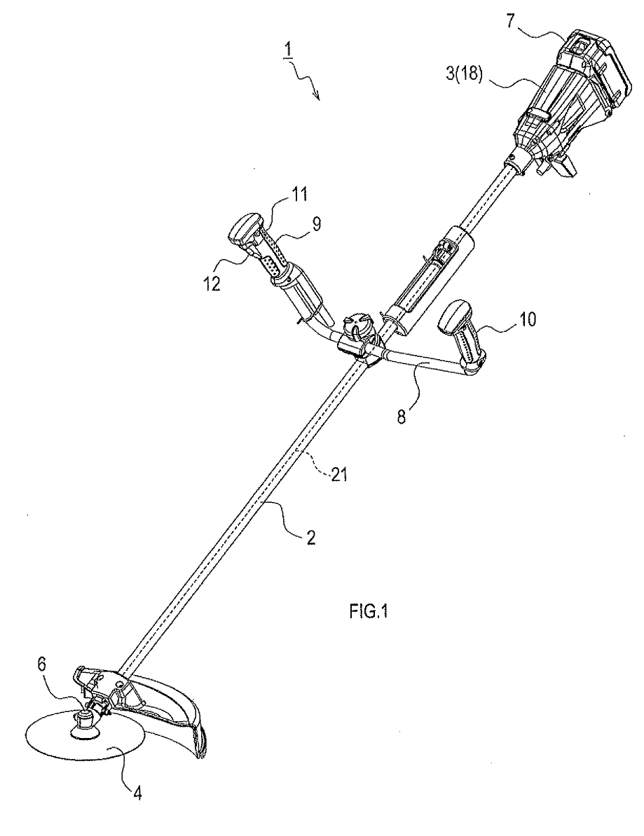

As shown in FIG. 1, an electric power tool 1, which is configured as a so-called brush cutter for cutting weeds and small trees, includes a shaft pipe 2, a motor unit 3, and a cutter 4.

The shaft pipe 2 is formed to be a hollow rod. A motor unit 3 is provided at one end of the shaft pipe 2, while a cutter 4 is provided at the other end of the shaft pipe 2 in a detachable/attachable manner. Hereinafter, the end of the shaft pipe 2 at which the motor unit 3 is provided is referred to as the “upper end” arid the end at which the cutter 4 is provided is referred to as the “lower end”.

The cutter 4 as a whole is formed to have substantially a disk-like shape. More specifically, a central portion of the cutter 4 is formed of a material having a rigidity of a predetermined specified value or more (for example, a metal material or a super-hard synthetic resin), and is molded into a disk-like shape or a columnar shape. Also, a periphery of the cutter 4 has a plurality of not-shown blades. The plurality of blades may be thin plates formed of a same material as, or of a different material from the central portion of the cutter 4, or may be resin cords (so-called nylon cords) formed of a synthetic resin in a string shape.

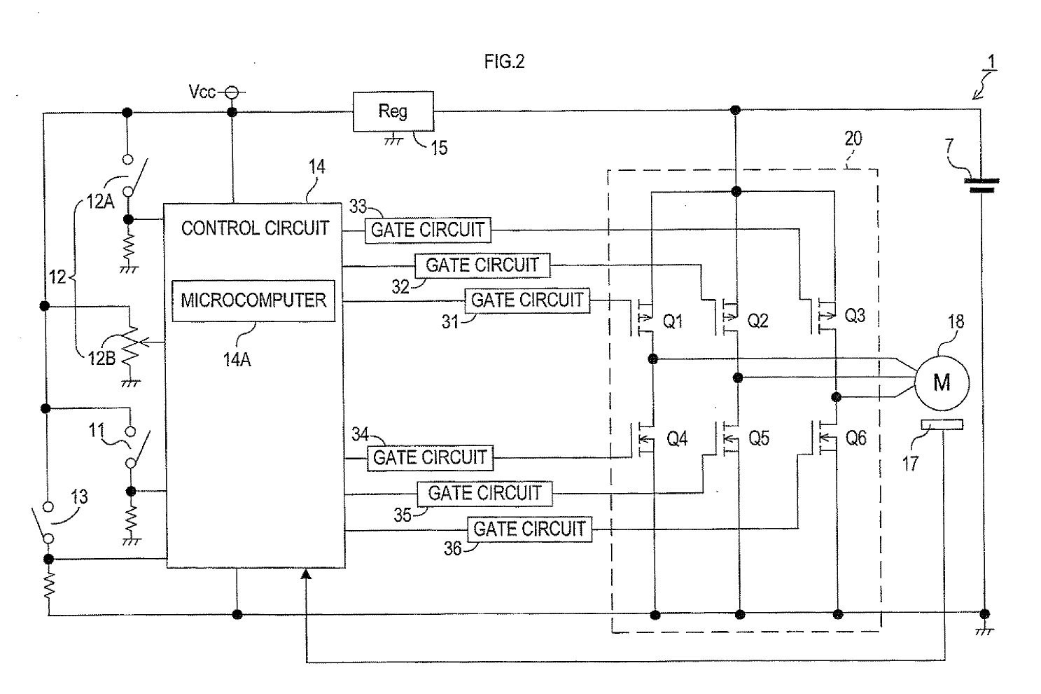

Also, a handle 8 is provided in a vicinity of an axially middle position of the shaft pipe 2. The handle 8 includes a right-hand grip 9 which a user of the electric power tool 1 holds with the right hand and a left-hand grip 10 which the user holds with the left hand. The right-hand grip 9 includes a lock-off switch 11, a trigger switch 12, and a forward-reverse selector switch 13 (see FIG. 2).

The motor unit 3 includes a battery 7 and an electric motor 18.

The battery 7 includes a rechargeable secondary battery (such as a lithium-ion secondary battery) inside the battery 7. The battery 7 is configured to be attachable and detachable to and from the motor unit 3.

In the electric motor 18, when electric current is supplied from the battery 7 to a coil of the electric motor 18, a rotor of the electric motor 18 having a drive shaft is rotated.

A driving force transmission shaft (hereinafter, simply referred to as the “transmission shaft”) 21 is housed inside the shaft pipe 2. The transmission shaft 21 is connected to the drive shaft of the electric motor 18 at an upper end of the transmission shaft 21, and is connected to the cutter 4 at a lower end of the transmission shaft 21 via a gear unit 6 including a plurality of gears.

With the above-described configuration, a rotational driving force of the electric motor 18 is transmitted to the cutter 4 via the transmission shaft 21 and the gear unit 6.

### <Electrical Configuration of the Electric Power Tool>

As shown in FIG. 2, the electric power tool 1 includes the above-described electric motor 18, a bridge circuit 20, six gate circuits 31-36, and a control circuit 14.

The electric motor 18 is configured as a well-known three-phase brushless DC motor. When an electric current is sequentially supplied to coils for respective phases U, V, and W, the rotor of the electric motor 18 is rotated. The electric motor 18 in the first embodiment includes a position detection unit 17 for detecting a rotation angle of the rotor. The position detection unit 17 includes a well-known Hall element.

The coils for the respective phases U, V, and W of the electric motor 18 are connected to the battery 7 via the bridge circuit 20.

The bridge circuit 20 is a well-known three-phase bridge circuit, including six switching devices Q1-Q6. In the bridge circuit 20, a pair of serially connected switching devices Q1, Q4, a pair of serially connected switching devices Q2, Q5, and a pair of serially connected switching devices Q3, Q6 are parallely connected among one another between a positive electrode and a negative electrode of the battery 7. Also, the coils for the respective phases U, V, and W of the electric motor 18 are connected, respectively, to a point between the switching devices Q1 and Q4, a point between the switching devices Q2 and Q5, and a point between the switching devices Q3 and Q6.

Specifically, the bridge circuit 20 is configured to be capable of driving the rotor of the electric motor 18 in any rotation direction from a forward rotation direction and a reverse rotation direction by appropriate control of on/off of the switching devices Q1-Q6. The forward rotation direction here means a direction of rotating the cutter 4 at the time of cutting weeds and small trees. In contrast, the reverse rotation direction means a rotation direction which is opposite to the forward rotation direction and used when removing weeds or the like tangled in the cutter 4. In this regard, the electric power tool 1 in the first embodiment is configured such that a rotation speed in the reverse rotation direction is lower than a rotation speed in the forward rotation direction.

The gate circuits 31-36 are configured to appropriately turn on/off the respective switching devices Q1-Q6 in the bridge circuit 20 in accordance with drive signals inputted from the control circuit 14 to the gate circuits 31-36, respectively.

The control circuit 14 includes a well-known microcomputer 14A provided with a CPU, a memory, an I/O, etc.

A constant voltage power circuit (Reg) 15 is connected to the control circuit 14, and the control circuit 14 is configured to operate by a predetermined control voltage Vcc (for example, 5VDC) generated by reducing a direct current voltage (for example, 36VDC) of the battery 7 by means of the Reg 15.

The lock-off switch 11, the trigger switch 12, and the forward-reverse selector switch 13 are connected to the control circuit 14.

The lock-off switch 11 is a switch to prevent the user of the electric power tool 1 from erroneously driving the electric motor 18. More specifically, when the lock-off switch 11 is turned off, a logical level of a voltage of a signal (a drive inhibition signal) inputted from the lock-off switch 11 to the control circuit 14 is set to a low level (that is, driving of the electric motor 18 is inhibited), while when the lock-off switch 11 is turned on, the logical level of the voltage of the drive inhibition signal is set to high level (driving of the electric motor 18 is permitted).

The forward-reverse selector switch 13 is a switch with which the user of the electric power tool 1 sets the rotation direction of the rotor of the electric motor 18 to one of the forward rotation direction and the reverse rotation direction. When the forward-reverse selector switch 13 is turned off, a logical level of a voltage of a signal (a forward rotation signal) inputted from the forward-reverse selector switch 13 to the control circuit 14 is set to a low level, while when the forward-reverse selector switch 13 is turned on, the logical level of the voltage of the forward rotation signal is set to a high level.

The trigger switch 12, which includes a contact switch 12A and a variable resistor 12B, is configured to output to the control circuit 14 a signal (an operation signal) indicating whether or not the trigger switch 12 has been pulled and a signal (a speed command value Cv) having a voltage depending on an operation amount (a trigger stroke) of the trigger switch 12.

Also, a memory of the microcomputer 14A stores programs for various processes to be executed by the microcomputer 14A. In a later-described electric motor driving process, as one of the various processes, gate circuits 31-36 are controlled such that an electric current having an amount depending on the speed command value Cv is made to flow through the coils for the respective phases U, V, and W of the electric motor 18, and that when a predetermined specified condition is satisfied, a braking force is applied to the rotor of the electric motor 18.

The memory of the microcomputer 14A also stores various threshold values Th necessary for determining whether or not the specified condition is satisfied.

That is, the control circuit 14 outputs a drive signal to each of the gate circuits 31-36 such that the rotor of the electric motor 18 is rotated at a rotation speed depending on the speed command value Cv from the trigger switch 12 when both of the lock-off switch 11 and the trigger switch 12 are on.

### <Process in Control Circuit>

Hereinafter, a process executed by the control circuit 14 (or more precisely, by the microcomputer 14A) will be described.

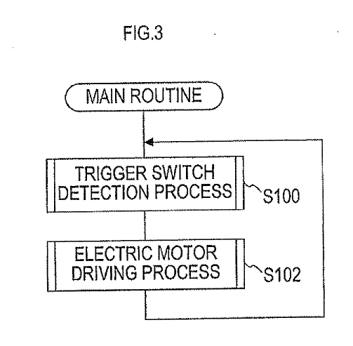

A main routine shown in FIG. 3 is activated when the lock-off switch 11 is turned on in the first embodiment. However, the main routine may be activated when the battery 7 is attached to the electric power tool 1 or when the trigger switch 12 is pulled.

As shown in FIG. 3, in the main routine, a trigger switch detection process (S100) and an electric motor driving process (S102) are sequentially executed in a repeated manner.

In the trigger switch detection process, the speed command value Cv inputted from the trigger switch 12 is detected. More specifically, a resistance value of the variable resistor 12B varies depending on an operation amount of the trigger switch 12 by the user, and a voltage depending on the resistance value is detected as the speed command value Cv.

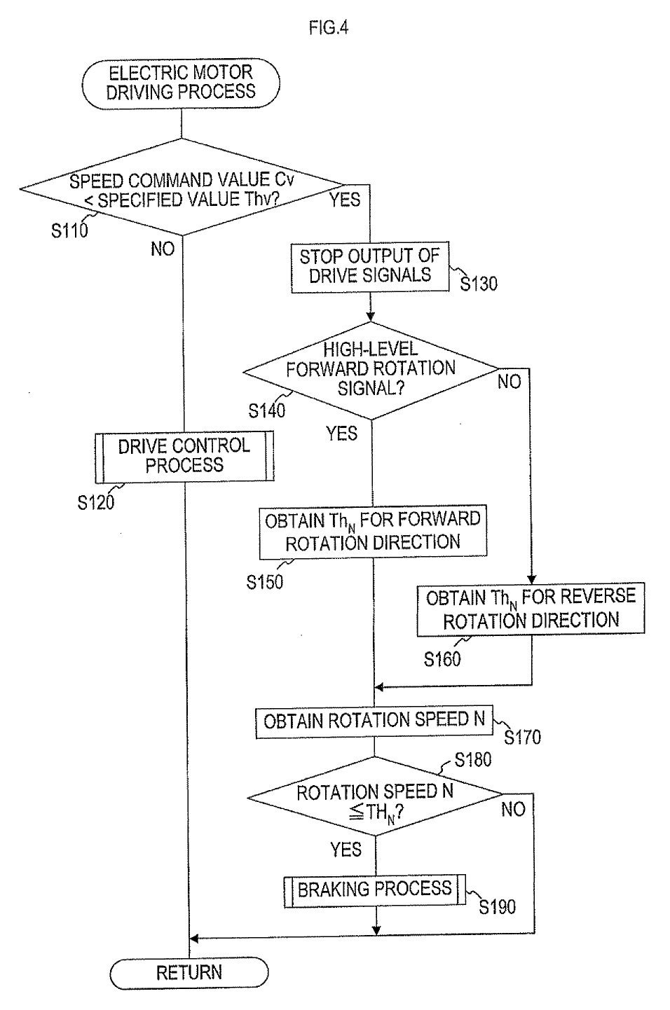

Subsequently, as shown in FIG. 4, in the electric motor driving process, it is determined whether or not the speed command value Cv detected in the trigger switch detection process (S100) is less than a specified value Thv, which is a previously specified threshold value (S110). The specified value Thv is a minute speed command value Cv based on which it can be considered that the trigger switch 12 is turned off. Accordingly, when the speed command value Cv is a value from 0 [V] to less than the specified value Thv (an example of a stop range in the present invention), the microcomputer 14A determines that a stop command of the electric motor 18 has been issued, and stops output of the drive signals to the gate circuits 31-36.

When it is determined in S110 that the speed command value Cv is equal to or more than the specified value Thv (S110: NO), the present process proceeds to S120. That is if it can be considered that both of the lock-off switch 11 and the trigger switch 12 are on, the present process proceeds to S120.

In S120, a previously defined drive control process is executed. The drive control process is a well-known process to output, to the gate circuits 31-36, drive signals that cause an electric current depending on the speed command value Cv to flow through the coils for the respective phases U, V, and W of the electric motor 18. When the drive control process is executed, the rotor of the electric motor 18 is rotated at a rotation speed (indicated by a rotation number per a unit time (e.g., one minute) in the first embodiment) in accordance with a trigger stroke (i.e., an operation amount) of the trigger switch 12. After the process in S120 is completed, the present electric motor driving process is terminated.

When it is determined in S110 that the speed command value Cv is less than the specified value Thv, i.e., the trigger switch 12 is off (S110: YES), the present process proceeds to S130. In S130, output of the drive signals is stopped. As a result, the gate circuits 31-36 turn off all the switching devices Q1-Q6, and the electric current to each of the coils for the respective phases U, V, and W of the electric motor 18 is shut off. Accordingly, the rotor of the electric motor 18 rotates through inertia after the shutoff of the electric current.

Subsequently, in S140, it is determined whether or not a forward rotation signal from the forward-reverse selector switch 13 is high level. When it is determined that the forward rotation signal is high level (S140: YES), then it is determined that a rotation direction of the rotor of the electric motor 18 is a forward rotation direction, and the present process proceeds to S150.

In S150, a specified rotation speed Th_{N} which is a previously specified threshold value is obtained. The specified rotation speed Th_{N} is set as a rotation speed at which braking of the rotor of the electric motor 18 should be started. In the first embodiment, a rotation speed, at which braking of the rotor should be started when a cutter having a largest inertia among a plurality of types of cutters attachable to the electric power tool 1 is attached to the electric power tool 1, is set as the specified rotation speed Th_{N}. Also, in the first embodiment, a value in a case where the rotation direction of the rotor of the electric motor 18 is a forward rotation direction and a value in a case where the rotation direction is a reverse rotation direction are set individually as the specified rotation speed Th_{N}. The specified rotation speed Th_{N} corresponding to the forward rotation direction may have the same value as that of the specified rotation speed Th_{N} corresponding to the reverse rotation direction, or may have a different value from that of the specified rotation speed Th_{N} corresponding to the reverse rotation direction.

When it is determined in S140 that the forward rotation signal from the forward-reverse selector switch 13 is low-level (S140: NO), it is determined that the rotation direction of the rotor of the electric motor 18 is the reverse rotation direction. Then, the present process proceeds to S160, in which the specified rotation speed Th_{N} corresponding to the reverse rotation direction is obtained.

Subsequently in S170, a rotation speed N [rpm] of the rotor of the electric motor 18 at the time is obtained based on an output from the position detection unit 17.

Then in S180, it is determined whether or not the rotation speed N obtained in S170 is equal to or less than the specified rotation speed Th_{N} obtained in either S150 or S160. When it is determined that the rotation speed N is equal to or less than the specified rotation speed Th_{N} (S180: YES), the present process proceeds to S190.

In S190, a previously defined braking process is executed. The braking process is a process to output to the gate circuits 31-36 such drive signals that turn on all the switching devices in either a group of the switching devices Q1-Q3 constituting the bridge circuit 20 or a group of the switching devices Q4-Q6 constituting the bridge circuit 20. When the braking process is executed, the coils for the respective phases U, V, and W of the electric motor 18 form short circuits. Then, a braking force is applied to the rotor of the electric motor 18 which is rotating through inertia, by so-called regenerative braking. When the process in S190 is completed, the present subroutine is terminated.

When it is determined in S180 that the rotation speed N exceeds the specified rotation speed Th_{N}, the electric motor driving process is terminated without executing S190.

### Effects of First Embodiment

As described above, in the electric motor driving process of the first embodiment, the braking process is executed when the rotation speed N becomes equal to or less than the specified rotation speed Th_{N} after electric current supply to the coils for the respective phases U, V, and W of the electric motor 18 is stopped.

That is to say, in the electric motor driving process of the first embodiment, it is waited that kinetic energy owned by the cutter 4 rotating through inertia is reduced to equal to or less than a predetermined value, and then the braking process is executed.

Particularly in the electric motor driving process of the first embodiment, the specified rotation speed Th_{N} to be compared with the rotation speed N is a value corresponding to a cutter having a maximum inertia moment about the drive shaft of the electric motor 18 as a rotation center among the various types of cutters attachable to the electric power tool 1. Accordingly, regardless of the cutter attached to the electric power tool 1, the braking process may be executed after the kinetic energy in the cutter during rotation becomes equal to or less than the predetermined value.

As a result, according to the electric power tool 1 of the first embodiment, the braking force is applied to the rotor after the rotation speed N is reduced, and thereby recoil exerted on the electric power tool 1 due to the braking force may be reduced. Thus, deterioration in usability of the electric power tool 1 resulting from braking of the electric motor 18 may be suppressed.

Also, according to the electric power tool 1, it is possible to suppress an unexpectedly large kinetic energy from being exerted on the transmission shaft or the gears in the gear unit 6. Thus, it is possible to suppress fatigue accumulated in the transmission shaft and the gears, and thereby lengthen the lives of the transmission shaft and the gears.

In the first embodiment, the cutter 4 is an example of an object to be driven in the present invention, S170 in the electric motor driving process is an example of a rotation speed detection device in the present invention, S190 is an example of a brake device in the present invention, and S180 is an example of a rotation speed-based activation device in the present invention.

Further, in the first embodiment, S150 and S160 are examples of a specified speed setting device in the present invention, the trigger switch 12 is an example of a rotation speed command switch in the present invention, S100 in the main routine is an example of a command value obtaining device in the present invention.

### Second Embodiment

Next, a second embodiment of the present invention will be described.

An electric power tool described in the second embodiment is different from the electric power tool 1 described in the first embodiment only in terms of the electric motor driving process executed by the control circuit 14.

In the second embodiment, therefore, the electric motor driving process which is different from the electric power tool 1 of the first embodiment will be mainly described, while the same constitutions as in the electric power tool 1 of the first embodiment will be assigned the same reference numerals and descriptions thereof will be omitted.

### <Electric Motor Driving Process>

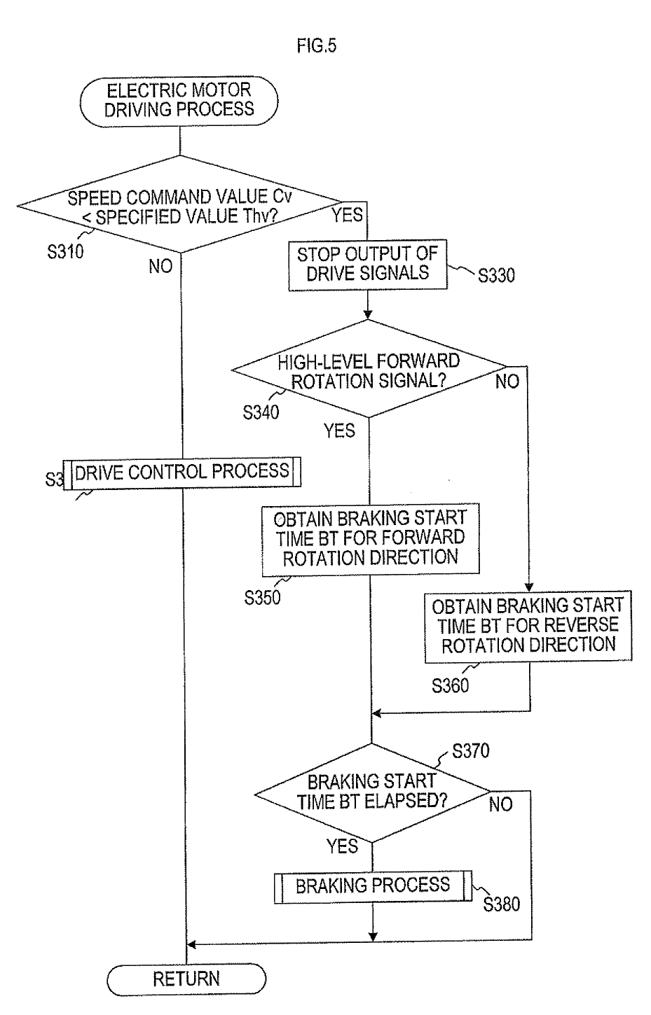

As shown in FIG. 5, in the electric motor driving process in the second embodiment, it is first determined whether or not the speed command value Cv is less than a specified value Thv (S310).

When it is determined in S310 that the speed command value Cv is equal to or more than the specified value Thv (S310: NO), the present process proceeds to S320. Specifically, if it can be considered that both of the lock-off switch 11 and the trigger switch 12 are on, the present process proceeds to S320.

In S320, the drive control process is executed. The drive control process in the second embodiment is the same process as the drive control process described in the first embodiment. After completing the process in S320, the present electric motor driving process is terminated.

When it is determined in S310 that the speed command value Cv is less than the specified value Thv (S310: YES), it is determined that the trigger switch 12 has been turned off, and the present process proceeds to S330. In S330, output of the drive signals is stopped. Specifically, the gate circuits 31-36 turn off all the switching devices Q1-Q6, to thereby shut off the electric current to the coils for the respective phases U, V, and W of the electric motor 18.

Subsequently in S340, it is determined whether or not the forward rotation signal from the forward-reverse selector switch 13 is high level. When it is determined that the forward rotation signal is high level (S340: YES), it is determined that the rotation direction of the rotor of the electric motor 18 is the forward rotation direction, and the present process proceeds to S350.

In S350, a braking start time ST (an example of a braking control start time in the present invention), which is a previously specified time length, is obtained. The time length specified as the braking start time BT is a time length required from when the trigger switch 12 is turned off until the kinetic energy owned by the cutter 4 becomes equal to or less than a predetermined set value. The kinetic energy owned by the cutter 4 is mentioned here based on an assumption that the cutter 4 is rotating at a maximum speed of the electric motor 18. A time length from when the trigger switch 12 is turned off until the kinetic energy owned by a cutter, which has a maximum inertia among the plurality of types of cutters attachable to the electric power tool 1, becomes equal to or less than a predetermined set value is set as the braking start time BT in the second embodiment.

In the second embodiment, a braking start time BT in a case where the rotation direction of the rotor of the electric motor 18 is the forward rotation direction, and a braking start time BT in a case where the rotation direction is the reverse rotation direction are individually set. For example, the braking start time BT for the reverse rotation direction is specified as a shorter time length than the braking start time BT for the forward rotation direction.

In S350 of the second embodiment, the braking start time BT for the forward rotation direction is obtained.

On the other hand, when it is determined in S340 that the forward rotation signal from the forward-reverse selector switch 13 is low-level (S340: NO), it is determined that the rotation direction of the rotor of the electric motor 18 is the reverse rotation direction, and the present process proceeds to S360, in which a braking start time BT for the reverse rotation direction is obtained.

Subsequently in S370, it is determined whether or not an elapsed time since the trigger switch 12 is turned off is longer than the braking start time BT. When it is determined that the elapsed time is longer than the braking start time BT (S370: YES), the present process proceeds to S380. That is, when the braking start time BT has elapsed since the trigger switch 12 is turned off, the present process proceeds to S380.

In S380, a previously defined braking process is executed. The braking process executed in the second embodiment is the same process as the braking process described in the first embodiment. After completing the process in S380, the present electric motor driving process is terminated.

When it is determined in S370 that the braking start time BT has not elapsed since the trigger switch 12 is turned off (S370: NO), the electric motor driving process is promptly terminated without executing the braking process in S380.

### Effects of Second Embodiment

In the electric motor driving process of the second embodiment, as described above, the braking process is executed when the braking start time BT has elapsed since the trigger switch 12 is turned off.

Particularly, the braking start time BT in the second embodiment is set as the time length required until when the kinetic energy owned by the cutter 4 during rotation becomes equal to or less than a predetermined set value.

Accordingly, also in the electric motor driving process of the second embodiment, reduction in kinetic energy owned by the cutter 4 rotating through inertia to equal to or less than the predetermined value is waited for, and then the braking process is executed in the same manner as in the electric motor driving process described in the first embodiment.

As a result, the same effects as in the electric power tool 1 of the first embodiment may be achieved also in the electric power tool of the second embodiment.

The electric power tool of the second embodiment is configured such that the rotation speed in the reverse rotation direction is lower than the rotation speed in the forward rotation direction. As a result, even if the rotor is rotated in the reverse rotation direction at a maximum speed, the kinetic energy owned by the rotating cutter is smaller than in a case where the rotor is rotated in the forward rotation direction at a maximum speed. Also, in the second embodiment, the braking start time BT for the reverse rotation direction is specified as a shorter time length than the braking start time BT for the forward rotation direction.

Therefore, according to the electric power tool of the second embodiment, the braking process can be executed at an appropriate timing even when the rotor is rotated in the reverse rotation direction.

Further, the braking start time BT for the reverse rotation direction may be the same as or different from the braking start time BT for the forward rotation direction.

In the second embodiment, S370 in the electric motor driving process is an example of a time-based activation device in the present invention, and S350 and S360 are an example of a time setting device in the present invention.

### Third Embodiment

Next, a third embodiment of the present invention will be described.

An electric power tool of the third embodiment is different from the electric power tool 1 described in the first and second embodiments only in the electric motor driving process executed by the control circuit 14.

In the third embodiment, therefore, the description will be given mainly on the electric motor driving process, which is different from that in the electric power tool 1 described in the first and second embodiments, and the same constitutions as those in the electric power tool 1 described in the first and second embodiment will be assigned the same reference numerals, respectively, and will not be described further.

### <Electric Motor Driving Process>

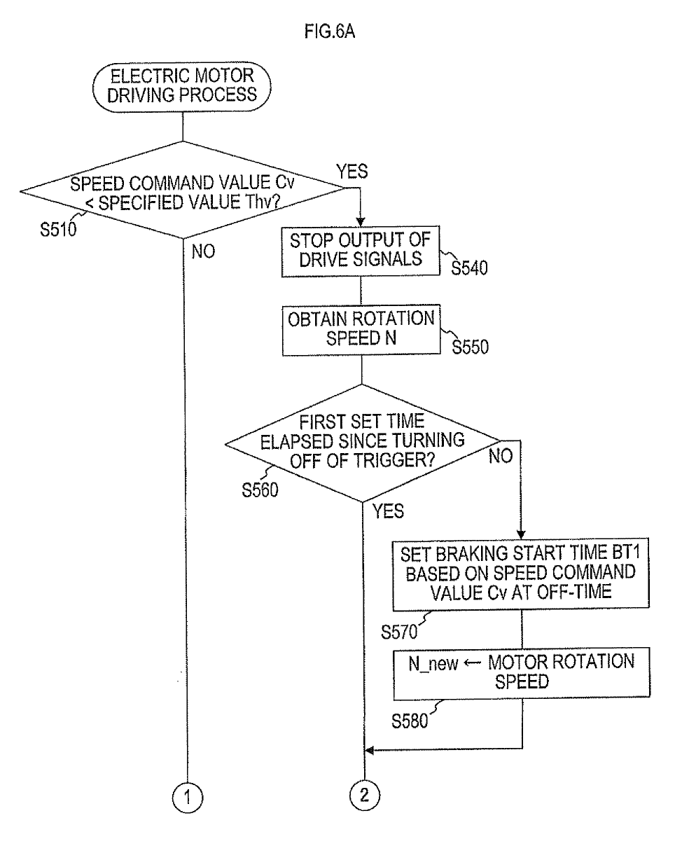

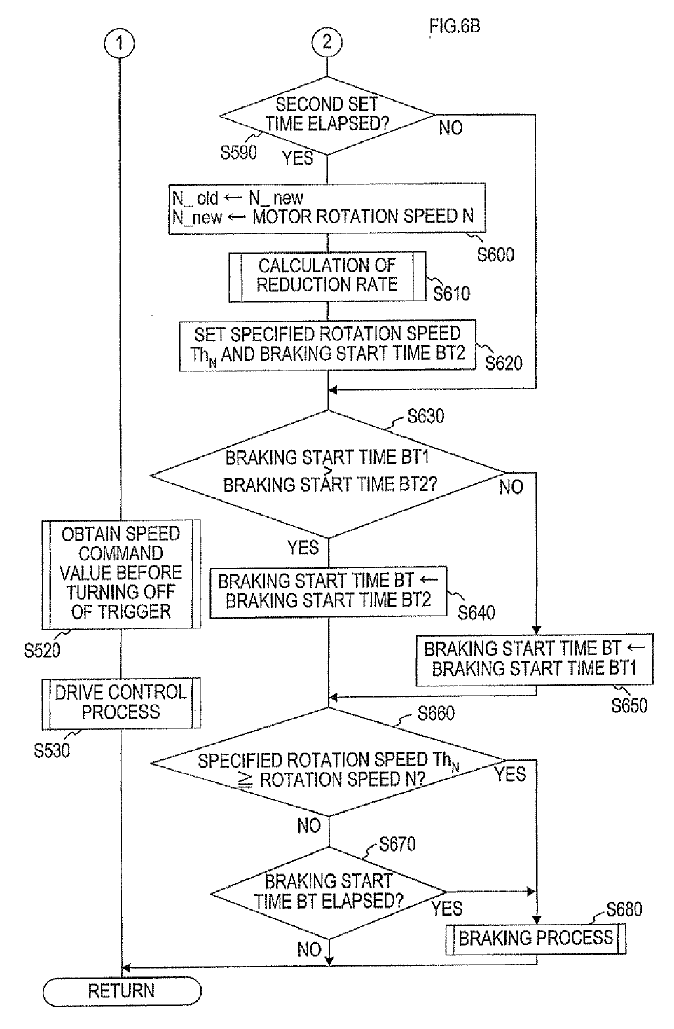

As shown in FIG. 6A-6B, in the electric motor driving process of the third embodiment, it is first determined whether or not the speed command value Cv is less than a specified value Thv (S510). When it is determined in S510 that the speed command value Cv is equal to or more than the specified value Thv (S510: NO), the present process proceeds to S520. Specifically, if it can be considered that both of the lock-off switch 11 and the trigger switch 12 are on, the present process proceeds to S520.

In S520, a speed command value Cv before the speed command value Cv becomes less than the specified value Thv, that is, before the trigger switch 12 is turned off is obtained, in order to use the value in S570 described later.

Subsequently in S530, the drive control process is executed. The drive control process of the third embodiment is the same as the drive control process described in the first and second embodiments. After completing the process in S530, the present electric motor driving process is terminated.

When it is determined in S510 that the speed command value Cv is less than the specified value Thv (S510: YES), it is determined that the trigger switch 12 is turned off, and the present process proceeds to S540. In S540, output of the drive signals is stopped. More specifically, the gate circuits 31-36 turn off all of the switching devices Q1-Q6, to thereby shut off electric current to the coils for the respective phases U, V, and W in the electric motor 18.

Subsequently in S550, a rotation speed N, at a current time point, of the rotor of the electric motor 18 is obtained based on an output from the position detection unit 17.

Subsequently in S560, it is determined whether or not a first set time, which is a previously specified time length (for example, several dozen [ms]), has elapsed since it is first determined in S510 that the speed command value Cv is less than the specified value Thv. When it is determined in S560 that the first set time has not elapsed (S560: NO), the present process proceeds to S570. That is, a condition for proceeding to S570 is that it is immediately after the trigger switch 12 is turned off.

In S570, a braking start time BT1 is set based on the speed command value Cv immediately before the trigger switch 12 is turned off (hereinafter, referred to as an “off-time command value Cvf”), which has been obtained in S520.

The braking start time BT1 is a time length required from when the trigger switch 12 is turned off until the kinetic energy owned by the cutter 4 during rotation becomes equal to or less than a predetermined set value. In S570, the larger the off-time command value Cvf is, the longer the time length is set to be. The off-time command value Cvf is a speed command value Cv at a previously specified time (for example, several [ms]) before a time point when it is first determined in S510 that the speed command value Cv is less than the specified value Thv.

More specifically, in S570, the faster the rotation speed of the rotor immediately after the trigger switch 12 is turned off, the larger the kinetic energy owned by the cutter 4 during rotation becomes, and thus, a longer time length is set as the braking start time BT1.

Subsequently in S580, the rotation speed N of the motor 12 is set to a first rotation speed N_new, and the present process proceeds to S590.

If it is determined in 560 that the first set time has elapsed since it is determined in S510 that the speed command value Cv is less than the specified value Thv, the present process also proceeds to S590.

Then in S590, it is determined whether or not a second set time, which is a previously specified time length (for example, several dozen [ms]), has elapsed since the present process proceeds to S600 last time. When it is determined that the second set time has elapsed (S590: YES), the present process proceeds to S600.

In S600, the rotation speed N, which has been set to the first rotation speed N_new from when S600 is executed last time until when the present process proceeds to S600 this time, is treated as a second rotation speed N_old. Also in S600, the rotation speed N obtained in S550 is set to the first rotation speed N_new. That is, once the present process proceeds to S600, an earlier obtained rotation speed N is treated as the second rotation speed N_old, while a later obtained rotation speed N is treated as the first rotation speed N_new as the time passes.

When S600 is executed for the first time, a value of the first rotation speed N_new set in S580 is an initial value of the first rotation speed N_new.

Subsequently in S610, a reduction rate at which the rotation speed reduces from the second rotation speed N_old to the first rotation speed N_new during a predetermined unit time period is calculated.

In S620, a specified rotation speed and a braking start time which correspond to the reduction rate calculated in S610 are set as the specified rotation speed Th_{N} and the braking start time BT2, respectively.

The specified rotation speed which corresponds to the reduction rate is a rotation speed of the rotor associated with the reduction rate. It is to be noted that the rotation speed corresponding to the reduction rate, which is a rotation speed at which the kinetic energy owned by the cutter 4 during rotation is equal to or less than the predetermined set value, becomes larger as the reduction rate becomes larger.

This is because the kinetic energy in the cutter 4 during rotation has lower tendency to decrease and a time required until the kinetic energy becomes equal to or less than a predetermined set value will be longer as the reduction rate becomes smaller.

The braking start time which corresponds to the reduction rate is a time length associated with the reduction rate. It is to be noted that the time length associated with the reduction rate, which is a time length required from when the trigger switch 12 is turned off until the kinetic energy owned by the cutter 4 during rotation becomes equal to or less than the predetermined set value, will be shorter as the reduction rate becomes larger.

After setting the specified rotation speed Th_{N} and the braking start time BT2 in S620 as described above, the present process proceeds to S630.

In S630, it is determined whether or not the braking start time BT2 set in S620 is smaller than the braking start time BT1 set in S570. When it is determined in S630 that the braking start time BT2 is smaller than the braking start time BT1 (S630: YES), the present process proceeds to S640. When it is determined in S630 that the braking start time BT2 is equal to or more than the braking start time BT1 (S630: NO), the present process proceeds to S650. If the present process proceeds to S630 without ever executing the process in S620, no appropriate value is set as the braking start time BT2. Therefore, it is determined in S630 that the braking start time BT2 is equal to or more than the braking start time BT1.

In S640, the braking start time BT2 is set as the braking start time BT to be used for determination in S670 as described later. Then, the present process proceeds to S660. On the other hand, in S650, the braking start time BT1 is set as the braking start time BT to be used for determination in S670. Then, the present process proceeds to S660.

When it is determined in S590 that the second set time has not elapsed since a time when the present process proceeds to S600 last time, the present process proceeds to S630 without executing the processes in S600 to S620.

In S660, it is determined whether or not the rotation speed N obtained in S550 is equal to or less than the specified rotation speed Th_{N} set in S620. When it is determined that the rotation speed N is larger than the specified rotation speed Th_{N} (S660: NO), the present process proceeds to S670. If the present process proceeds to S660 without ever executing the process in S620, it is determined in S660 that the rotation speed N is larger than the specified rotation speed Th_{N}.

Then in S670, it is determined whether or not an elapsed time since the trigger switch 12 is turned off is longer than the braking start time BT set in S640 or S650. When it is determined that the elapsed time is longer than the braking start time BT (S670: YES), the present process proceeds to S680. That is, the present process proceeds to S680 when the braking start time BT has elapsed since the trigger switch 12 is turned off. Also, when it is determined in S660 that the rotation speed N is equal to or less than the specified rotation speed Th_{N} (S660: YES), the present process proceeds to S680.

In S680, a braking process is executed. The braking process executed in the third embodiment is the same as the braking process described in the first and second embodiments. After completing the process in S680, the present electric motor driving process is terminated.

When it is determined in S670 that the braking start time BT has not elapsed since the trigger switch 12 is turned off (S670: NO), the present electric motor driving process is terminated without executing the braking process in S680.

### Effects of Third Embodiment

As described above, in the electric motor driving process of the third embodiment, the braking process is executed when the braking start time BT has elapsed since the trigger switch 12 is turned off, or when the rotation speed N becomes equal to or less than the specified rotation speed Th_{N}.

That is to say, in the electric motor driving process of the third embodiment, the braking process is executed after waiting for the kinetic energy owned by the cutter 4 rotating through inertia to be reduced to equal to or less than a set value.

Therefore, according to the electric power tool of the third embodiment, it is also possible to suppress an unexpectedly large kinetic energy (stress) from being exerted on the transmission shaft or the gears in the gear unit 6, in a same manner as in the electric power tool of the first embodiment or the second embodiment.

Further, according to the electric power tool of the third embodiment, the reduction rate to be used for setting the braking start time BT and the specified rotation speed Th_{N} is calculated each time the second set time has elapsed since the trigger switch 12 is turned off.

Consequently, according to the electric power tool of the third embodiment, the braking process can be executed at an appropriate timing depending on a load.

Particularly in the electric motor driving process of the third embodiment, setting of the braking start time BT is executed immediately after the trigger switch 12 is turned off. Therefore, according to the electric power tool of the third embodiment, it is possible to specify the braking start time BT depending on a state of use of the electric power tool when an attempt is made to stop the rotation of the rotor of the electric motor 18.

In the third embodiment, S610 in the electric motor driving process is an example of a reduction rate calculation device in the present invention, S620 is an example of a specified speed setting device and a time setting device in the present invention, and S570 is an example of an estimation device in the present invention.

### Fourth Embodiment

Next, a fourth embodiment of the present invention will be described.

An electric power tool of the fourth embodiment has a different electric motor and a different electrical configuration for driving the electric motor as compared with the electric power tool 1 described in the first to third embodiments.

Therefore, in the fourth embodiment, the different electric motor and the different electrical configuration for driving the electric motor from those in the electric power tool 1 of the first to third embodiments will be mainly described, and the same configurations and processes as in the electric power tool 1 of the first to third embodiments will be assigned the same reference numerals and further description thereof will be omitted.

### <Electrical Configuration of Electric Power Tool>

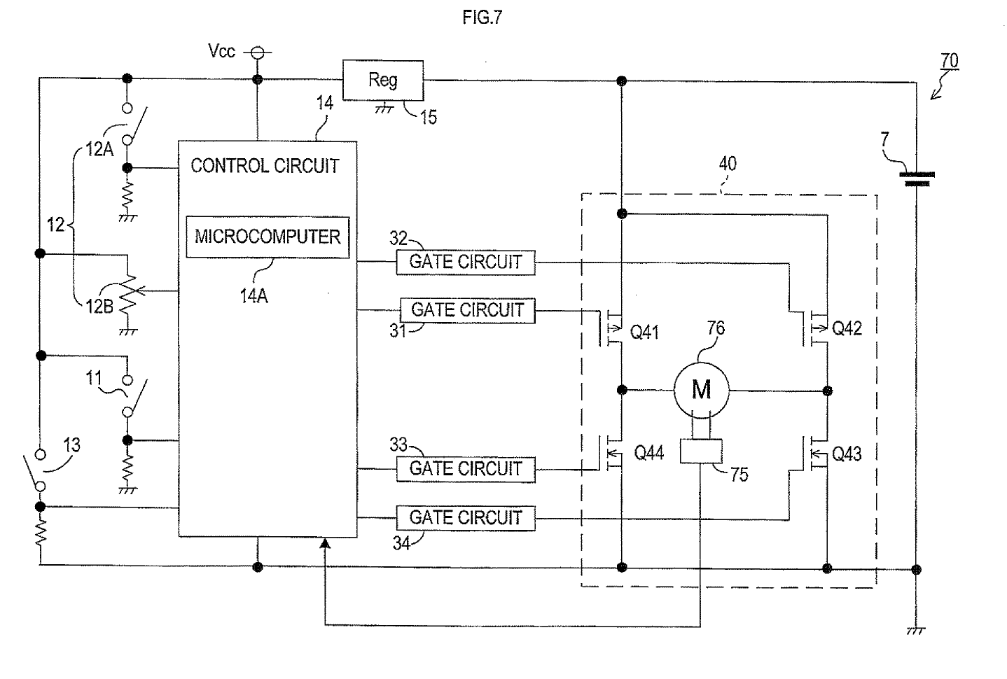

FIG. 7 is a block diagram showing the electrical configuration of the electric power tool in the fourth embodiment.

As exemplarily shown in FIG. 7, an electric power tool 70 in the fourth embodiment includes an electric motor 76 configured as a brushed DC motor.

A position detection unit 75 to detect a rotation angle of the drive shaft is provided to a drive shaft of the electric motor 76. The position detection unit 75 includes a well-known encoder (a so-called rotary encoder), and outputs a detection signal from the encoder to the control circuit 14.

The electric motor 76 is connected to the battery 7 through a bridge circuit 40. The bridge circuit 40 is a well-known H bridge circuit constituted by four switching devices Q41-Q44.

A rotor of the electric motor 76 rotates in the forward rotation direction when the switching device Q41 and the switching device Q43 are turned on, and rotates in the reverse rotation direction when the switching device Q42 and the switching device Q44 are turned on.

### <Braking Process>

In a braking process of the fourth embodiment, drive signals are outputted to the gate circuits 31-34 so as to turn on only one of a group of the switching devices Q41 and Q42 which function as high-side switches, and a group of the switching devices Q43 and Q44 which function as low-side switches. Due to such braking process, a short circuit is made between both ends of a coil of the electric motor 76. As a result, a so-called regenerative braking occurs, and a braking force is applied to the rotor of the electric motor 76 during rotation through inertia.

### Effects of Fourth Embodiment

As described above, in the electric power tool 70 of the fourth embodiment, the brushed DC motor is used as a power source to rotate the cutter 4, and the H bridge circuit is used as a drive circuit to drive the brushed DC motor.

Also in a case where the electric power tool 70 is configured as above, it is possible to apply a braking force to the rotor of the electric motor 76 after the kinetic energy owned by the rotating cutter 4 is reduced to equal to or less than a set value in a same manner as in the electric power tool 1 described in the first to third embodiments.

### Other Embodiments

Although some embodiments of the present invention have been described above, the present invention should not be limited to the first to fourth embodiments, but may be implemented in various forms within the scope not departing from the gist of the present invention.

For example, while setting of the specified rotation speed Th_{N} and the braking start time BT is not performed depending on the rotation direction of the rotor of the electric motor 18 in the electric motor driving process of the third embodiment, setting of the specified rotation speed Th_{N} and the braking start time BT may be performed depending on the rotation direction of the rotor of the electric motor 18 also in the electric motor driving process of the third embodiment. That is, process steps corresponding to S140-S160 in the first embodiment or process steps corresponding to S340-S360 in the second embodiment may be executed.

Alternatively, while the specified rotation speed Th_{N} and the braking start time BT are set depending on the rotation direction of the rotor of the electric motor 18 in the electric motor driving process of the first and second embodiments, the specified rotation speed Th_{N} and the braking start time BT need not be changed depending on the rotation direction of the rotor in the electric motor driving process of the first and second embodiments. That is, S140-S160 in the first embodiment and S340-S360 in the second embodiment may be omitted.

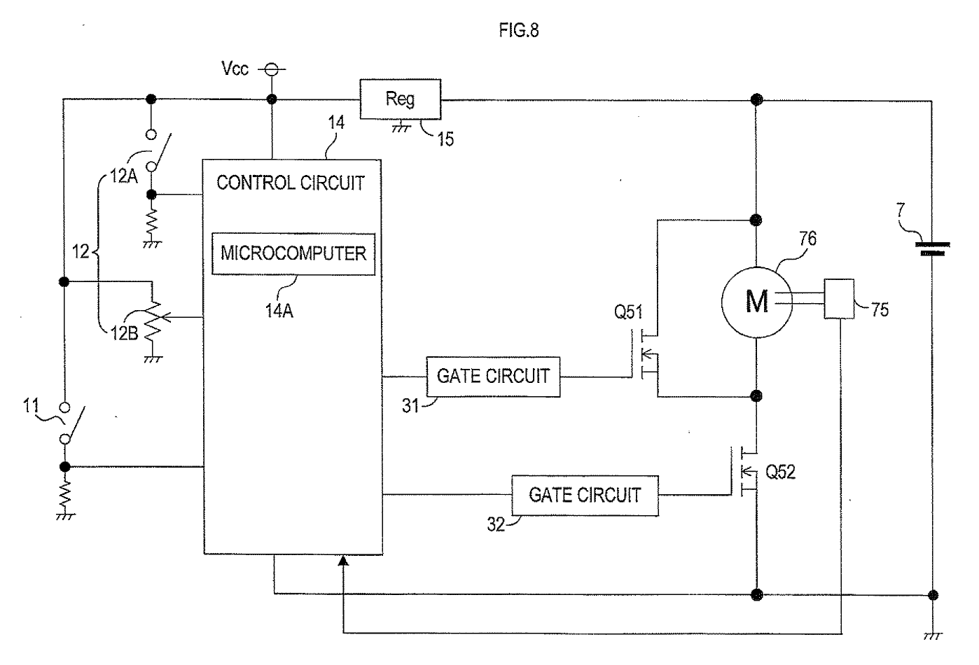

In this case, the electric motor 76 may be used as a power source to rotate the cutter 4 and a drive circuit shown in FIG. 8 may be used as a drive circuit to drive the electric motor 76 in the electric power tool 1.

The drive circuit shown in FIG. 8 includes two switching devices Q51 and Q52. The switching device Q52 is provided in series on an electric current path from the battery 7 to the electric motor 76, while the switching device Q51 is provided in parallel with the electric motor 76. In the switching device Q51, a drain of the switching device Q51 is connected to a positive electrode of the battery 7, while a source of the switching device Q51 is connected to between a drain of the switching device Q52 and a terminal of the electric motor 76.

That is, when the switching device Q51 is turned off and only the switching device Q52 is turned on, electric current is supplied to the coil of the electric motor 76, and the rotor of the electric motor 76 is rotated.

However, when the switching device Q52 is turned off and only the switching device Q51 is turned on, current supply from the battery 7 to the coil of the electric motor 76 is shut off, and a short circuit is made between both ends of the coil. As a result, a so-called regenerative braking occurs, and a braking force is applied to the rotor of the electric motor 76 during rotation through inertia.

In the first to fourth embodiments, an activation timing of the electric motor driving process may be, for example, a timing when the control circuit 14 is activated, that is, a timing when electric power is supplied to various components of the electric power tool 1.

Moreover, although the present invention is applied to an electric power tool configured as a brush cutter in the first to fourth embodiments, the present invention may be applied to an electric power tool in a different form, such as a grinder.

1. An oral care composition comprising:
a whitening agent;
an anionic surfactant present in an amount from 1.75% to 2.0% w/w; and
an orally acceptable carrier having a low water content.

2. The composition of claim 1, wherein the anionic surfactant is selected from the group consisting of sodium lauryl sulfate and sodium lauryl sulfoacetate.

3. The composition of any of claims 1 to 2, wherein the whitening agent is selected from the group consisting of a peroxide compound, a bound peroxide, a solid peroxide and mixtures thereof.

4. The composition of claim 3, wherein the peroxide compound is selected from the group consisting of hydrogen peroxide, peroxides of alkali and alkaline earth metals, organic peroxy compounds, peroxy acids, pharmaceutically acceptable salts thereof and mixtures thereof.

5. The composition of claim 4, wherein the hydrogen peroxide is present in an amount from 0.1% to 2% w/w.

6. The composition of claim 5, wherein the hydrogen peroxide is present in an amount from 1% to 2% w/w.

7. The composition of claim 3, wherein the bound peroxide includes a peroxide compound and a cross-linked polymer.

8. The composition of claim 7, wherein the cross-linked polymer is selected from the group consisting of polyvinyl pyrrolidone, polyacrylate, a polymethacrylate and polyitaconates.

9. The composition of claim 3, wherein the solid peroxide is selected from the group consisting of sodium perborate and urea peroxide.

10. The composition of any of claims 1 to 9, wherein the whitening agent is present in an amount from 0.1% to 30% w/w.

11. The composition of any of claims 1 to 10, wherein the anionic surfactant is present in an amount from 1.8% to 2% w/w.

12. The composition of any of claims 1 to 11, wherein the anionic surfactant is present in the amount of 2% w/w.

13. The composition of any of claims 1 to 12, wherein the water content of the orally acceptable carrier is from 0% to 4% w/w.

14. The composition of claim 1, wherein the water content of the orally acceptable carrier is from 0% to 2% w/w.

15. The composition of claim 1, wherein the water content of the orally acceptable carrier is from 0% to 1% w/w.

16. The composition of claim 1, wherein the water content of the orally acceptable carrier is less than 0.1% w/w.

17. The composition of claim 1, wherein the orally acceptable carrier is selected from the group consisting of polymers and copolymers of polyethylene glycol, ethylene oxide and propylene oxide.

18. The composition of any of claims 1 to 17, wherein the carrier further comprises fumed silica, an abrasive, a poloxamer and a flavoring agent.

19. The composition of any of claims 1 to 18, further comprising a fluoride salt.

20. The composition of any of claims 1 to 21, further comprising an active agent selected from the group consisting of an antimicrobial agent, an anti-inflammatory agent, a zinc salt and triclosan.

21. The composition of any of claims 1 to 20, wherein the composition comprises a single phase.

22. A method of improving patient compliance with an oral care composition, comprising applying to an oral surface an effective amount of the oral care composition of any of claims 1 to 21.

23. A method of whitening a tooth surface, the method comprising contacting the tooth surface with a composition of any of claims 1 to 21.
